(19) United States
(12) Patent Application Publication
(10) Pub. No.: US 2016/0262974 A1
(43) Pub. Date: Sep. 15, 2016

(54) AUTONOMIC NERVOUS SYSTEM BALANCING DEVICE AND METHOD OF USE

(71) Applicant: STRATHSPEY CROWN HOLDINGS, LLC, Newport Beach, CA (US)

(72) Inventors: Todd Mirzai, Honolulu, HI (US); Robert Edward Grant, Laguna Beach, CA (US); Matthew T. Case, Laguna HIlls, CA (US)

(21) Appl. No.: 14/643,564

(22) Filed: Mar. 10, 2015

(51) Int. Cl. A61H 23/02; G06F 17/30

(52) U.S. Cl. CPC A61H 23/02; G06F 17/30073; A61H 2201/5058; A61H 2205/027

(57) ABSTRACT

A system and method for balancing the Autonomic Nervous System (ANS) of a person to achieve a desired physiological response requires a computer for translating a measured physiological function into a fundamental tone, fₜₒₙₑ. In particular, the fundamental tone, fₜₒₙₑ, is based on an inflection between sympathetic and parasympathetic responses from the ANS of the person. Binaural frequencies (f₁ and f₂) are established to straddle the fundamental tone, fₜₒₙₑ, of the person, and are differentiated by a preselected beat frequency, f_{beat} (i.e. a brain wave frequency). A headphone is then used for simultaneously transmitting a respective binaural frequency (f₁ or f₂) to a respective auditory canal of the person, to thereby use the beat frequency, f_{beat}, for achievement of the desired physiological response. Operationally, once it has been ascertained by the computer, the fundamental tone, fₜₒₙₑ, can be retrieved from a backup service (i.e. the “cloud”).

### FIELD OF THE INVENTION

The present invention pertains to systems and methods for using vibration therapy to improve the health and wellness of the user. More particularly, the present invention pertains to systems and methods for generating brain wave vibrations to achieve a desired physiological response by stimulating a person with binaural beats of a fundamental tone that is uniquely characteristic of the Autonomic Nervous System (ANS) of the person being treated. The present invention is particularly, but not exclusively, useful for vibration therapy wherein the fundamental tone is based on a measured inflection (transition) that is detected between a sympathetic response and a parasympathetic response of the person being treated.

### BACKGROUND OF THE INVENTION

It is well known that the Autonomic Nervous System (ANS) of a person includes a sympathetic nervous system, a parasympathetic nervous system, and an enteric nervous system (i.e. relating to the intestines). Of these, the sympathetic and parasympathetic nervous systems are of particular importance for the present invention. Specifically, the sympathetic nervous system mobilizes and stimulates the body for action in what is typically referred to as the fight-or-flight response. On the other hand, the parasympathetic system is associated with activities that occur when the body is relatively at rest. It happens that the predominance of either nervous system (sympathetic or parasympathetic) is manifested by different physiological responses. Importantly, variations in these responses are measurable and can be audially induced. For instance, variations in a person's heart rate, or a change in bio-impedance, are measurable as physiological responses.

With respect to a nervous system response to auditory stimulation, it is to be appreciated and understood that while one tone (i.e. an auditory frequency vibration) will predominate to stimulate the sympathetic nervous system, another tone will not; and vice versa. Further, a transition (inflection) frequency can be empirically determined which will effectively identify a figurative boundary or interface between the sympathetic and the parasympathetic nervous systems. As used and recognized here, this transition (inflection) between nervous systems is characterized by a vibration frequency, f_{f}, which is unique to the person that is tested.

As is well known in the pertinent art, a person's brain produces brain waves that will produce discernable physiological responses from a person. For instance, an improved emotional state, i.e. relief from depression, or an induced state of relaxation, are examples of such responses. Typical brain waves, however, are of very low frequency, with most types being less than about 40 Hz. Consequently, brain waves are essentially inaudible. Nevertheless, we know that persons are aware of, and react to, brain waves.

One way by which persons can aurally perceive very low frequencies is by using a methodology commonly referred to as “binaural beats.” For an implementation of this methodology, two aurally perceptible binaural frequencies, f₁ and f₂, are generated. In this case the binaural frequencies are separated from each other by a beat frequency, f_{beat} (i.e. f_{beat}=f₂−f₁). As envisioned for the present invention, the beat frequency, f_{beat}, is selected to be the same as a particular brain wave frequency of interest. Thus, the binaural frequencies effectively carry the brain wave for aural perception.

In overview, the present invention recognizes that a unique fundamental vibration frequency, f_{f}, is simultaneously interactive with both the sympathetic nervous system and the parasympathetic nervous system in the ANS of a person. Therefore, using this fundamental vibration frequency, f_{f}, as a base, binaural frequencies, f₁ and f₂, can be used to generate a beat frequency, f_{beat} (i.e. a brain wave frequency), which will appropriately stimulate either the sympathetic or the parasympathetic nervous system of the person.

In light of the above, it is an object of the present invention to provide a system and a method for using sonic vibrations to balance the ANS of a person, wherein a fundamental frequency (tone) for the person is identified to influence both the sympathetic and the parasympathetic nervous systems. Another object of the present invention is to generate binaural frequencies based on the fundamental frequency (tone), wherein the binaural frequencies are differentiated by a preselected beat frequency that is equal to a brain wave which will elicit a desired physiological response. Still another object of the present invention is to provide a system and method for balancing the ANS of a person with a sonic vibration to achieve a desired physiological response which is easy to use, is simple to manufacture, and is comparatively cost effective.

### SUMMARY OF THE INVENTION

In accordance with the present invention, a system and method are provided for improving the health and wellness of a person by selectively balancing brain wave functions of the person with the person's Autonomic Nervous System (ANS). For the present invention, this results in achieving a desired physiological result such as a relief from depression, increased alertness and/or overall relaxation. In particular, as envisioned for the present invention, the desired physiological result is achieved by aurally stimulating the person with an appropriately selected brain wave frequency (vibration).

In overview, an operation of the present invention requires the manipulation of several frequency (vibration) considerations. For one, a physiological function such as a pronounced variation in the heart rate (frequency), or a bio-impedance, of the person is measured. Based on this measurement, a fundamental frequency, f_{f}, is established for the person. This fundamental vibration frequency, f_{f}, is considered to be indicative of a transition (inflection) between the sympathetic and parasympathetic systems of the person's ANS. The fundamental frequency, f_{f}, can then, if necessary, be appropriately targeted by octave variation techniques to establish a fundamental tone, fₜₒₙₑ, for subsequent use by the system. Once the fundamental tone, fₜₒₙₑ, for the person has been determined, it will serve as the basis for determining binaural frequencies, f₁ and f₂. For the present invention the binaural frequencies, f₁ and f₂, are selected to straddle the fundamental tone, fₜₒₙₑ (i.e. fₜₒₙₑ<fₜₒₙₑ<f₂). Further, the difference between the binaural frequencies, f₁ and f₂, is established to be equal to a beat frequency, f_{beat} (i.e. f_{beat}=f₂−f₁). In turn, the beat frequency, f_{beat}, is selected to equate with a selected brain wave frequency, and is preferably less than about 40 Hz. Specifically, f_{beat} is chosen to equal the value of a brain wave that is known to have a positive influence for the desired physiological result, e.g. treatment of a particular emotional state, or a manifested disease of the person using the system.

In cases where the fundamental vibration frequency, f_{f}, and the fundamental tone, fₜₒₙₑ, have an octave vibration relationship (i.e. 2fₜₒₙₑ−f_{f}=0), the analyzer uses octave variation techniques to move the fundamental vibration frequency, f_{f}, into a tone spectrum. In particular, the tone spectrum will include frequencies where each binaural frequency, f₁ and f₂, is less than 1,000 Hz. In some instances, however, it may happen that f_{f} will equal fₜₒₙₑ, and no targeting is required. In either case, it is preferable that each binaural frequency, f₁ and f₂, be less than around 1,000 Hz. As indicated above, f_{beat}, which is based on fₜₒₙₑ, is used for the present invention to aurally stimulate the person (user) and thereby achieve the desired physiological result.

Structurally, a system for balancing the Autonomic Nervous System (ANS) of a person to achieve a desired physiological response in accordance with the present invention includes a sensor for measuring a physiological function of the body of the person (e.g. a variation in heart rate). A computer is provided to then translate the physiological function that is measured by the sensor into the fundamental vibration frequency, f_{f}. As indicated above, the fundamental vibration frequency, f_{f}, will preferably comport with a transition (inflection) between a sympathetic response and a parasympathetic response of the person.

Also provided for the system of the present invention is an analyzer. Specifically, the analyzer is incorporated with the computer to isolate and evaluate a tone spectrum. In detail, the analyzer evaluates the fundamental vibration frequency, f_{f}, in its relationship with a tone spectrum to thereby establish a fundamental tone, fₜₒₙₑ, for the person (user). A selector, which is also incorporated with the computer and connected with the analyzer, is used to identify the binaural frequencies, f₁ and f₂, from within the tone spectrum. As noted above, the binaural frequencies, f₁ and f₂, are based on the fundamental tone, fₜₒₙₑ, of the person, and are different from each other by a preselected beat frequency, f_{beat} (e.g. a selected brain wave).

Additionally, the system of the present invention includes a database for archiving a library of tones. In particular, tones from this library can be selected for use as the fundamental tone, fₜₒₙₑ. Preferably, the database is located in an Internet backup service, such as the so-called “cloud.” In such a combination, a transceiver can be employed for connecting the computer with the database. The transceiver can then retrieve an appropriate fundamental tone, fₜₒₙₑ, from the database (cloud) for use by the analyzer in identifying the binaural frequencies, f₁ and f₂.

A headphone is used as part of the system for simultaneously transmitting a respective binaural frequency (i.e. f₁ or f₂) to a respective auditory canal of the person. As disclosed above, the binaural frequencies, f₁ and f₂, are used here to generate the beat frequency, f_{beat}, that is necessary for achievement of the desired physiological response. Recall, the beat frequency, f_{beat}, is preferably less than about 40 Hz. In an alternate embodiment, the headphone may consist of a pair of earbuds, with each earbud being individually engaged with a respective auditory canal of the person to transmit one of the binaural frequencies to the person (user).

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of components envisioned for use in the systems and methods of the present invention, including a representation of the interaction of the components required for an operation of the present invention;

FIG. 2 shows a person wearing a device, and a sensor, as envisioned for the present invention;

FIG. 3A is a frequency scale showing the general relationships between a fundamental vibration frequency, f_{f}, a fundamental tone, fₜₒₙₑ, and brain waves, together with their relevant audio range, tone spectrum, and ANS response;

FIG. 3B is a diagram depicting the relationship between a fundamental tone, fₜₒₙₑ, and a beat frequency, f_{beat}, together with the binaural frequencies for creating the beat frequency, f_{beat}; and

FIG. 3C is a table of brain waves and their respective frequency ranges for use with the present invention.

### DESCRIPTION OF THE PREFERRED EMBODIMENTS

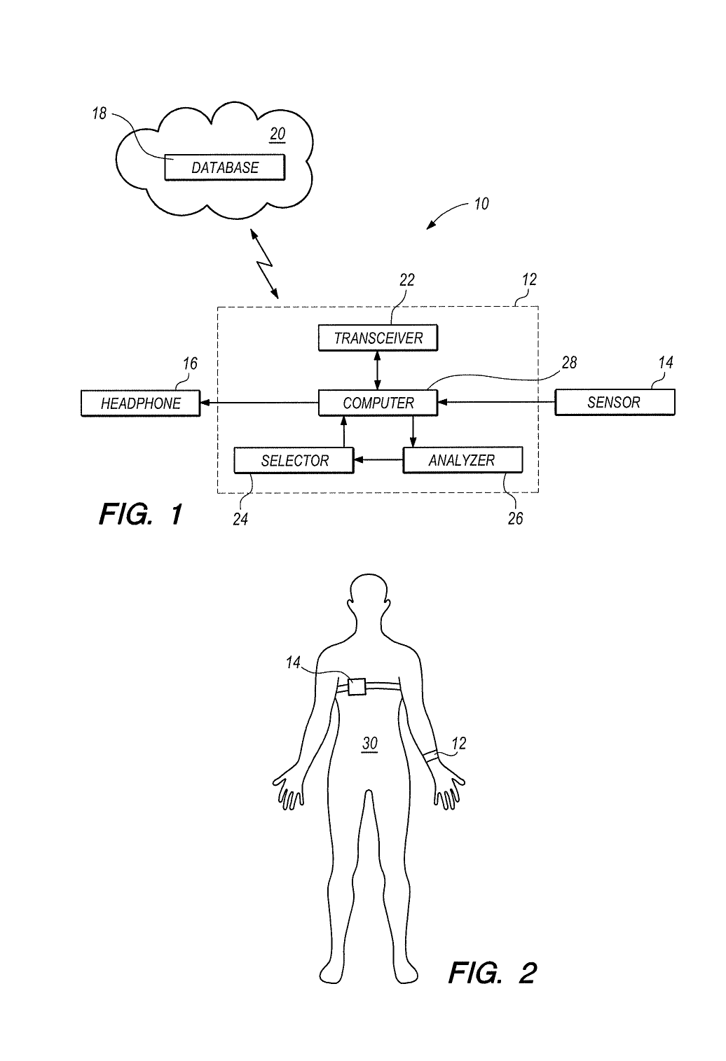

Referring initially to FIG. 1, a system for balancing a person's Autonomic Nervous System (ANS) to achieve a desired physiological response is shown and is generally designated 10. As shown, the system 10 includes an electronic device 12 that can be selectively connected to a sensor 14, and to a headphone 16. For its operation, the device 12 is connected in communication with a database 18 that, as shown, will be typically located at a backup service, such as in the cloud 20.

In greater detail, the device 12 is shown in FIG. 1 to include a transceiver 22, a selector 24 and an analyzer 26; all of which are directly connected electronically with a computer 28. Further, as indicated in FIG. 1, the device 12 is intended for wireless communication (e.g. Wi-Fi) with the database 18 that is located at the backup service (i.e. cloud 20). It is to be further appreciated that the device 12 is intended to be mobile, and it can be easily carried by a person (e.g. user 30), such as is shown in FIG. 2.

For a setup of the system 10, FIG. 2 indicates that the sensor 14 should be positioned on, or adjacent, the body of the user 30. In the event, sensor 14 needs to be sufficiently engaged with the body of the user 30 to accurately measure a physiological function. For purposes of setting up the system 10, the physiological function of interest will preferably be dependent on the heart rate of the user 30. Alternatively, the present invention envisions bio-impedance measurements of the body of the user 30.

A use of the system 10 requires its setup by measuring the heart rate of the user 30 to ascertain a fundamental vibration frequency, f_{f}. In the process of ascertaining the fundamental vibration frequency, f_{f}, the user 30 is subjected to various vibration frequencies (i.e. tones) in the audio range and a heart rate response is measured for each vibration frequency (tone).

As will be appreciated by the skilled artisan, a physiological response from the user 30 can be detected when either his/her sympathetic nervous system or the parasympathetic nervous system is stimulated by a sonic vibration frequency. Importantly, the sonic vibration frequencies that stimulate the parasympathetic nervous system are different from those that stimulate the sympathetic nervous system. Thus, a noticeable variation in heart rate (i.e. an inflection) will be detected whenever there is a transition between the parasympathetic response and the sympathetic response of the person, user 30. Specifically, the frequency at which this occurs is unique to the particular user 30, and is referred to herein as the fundamental vibration frequency, f_{f}, of the user 30.

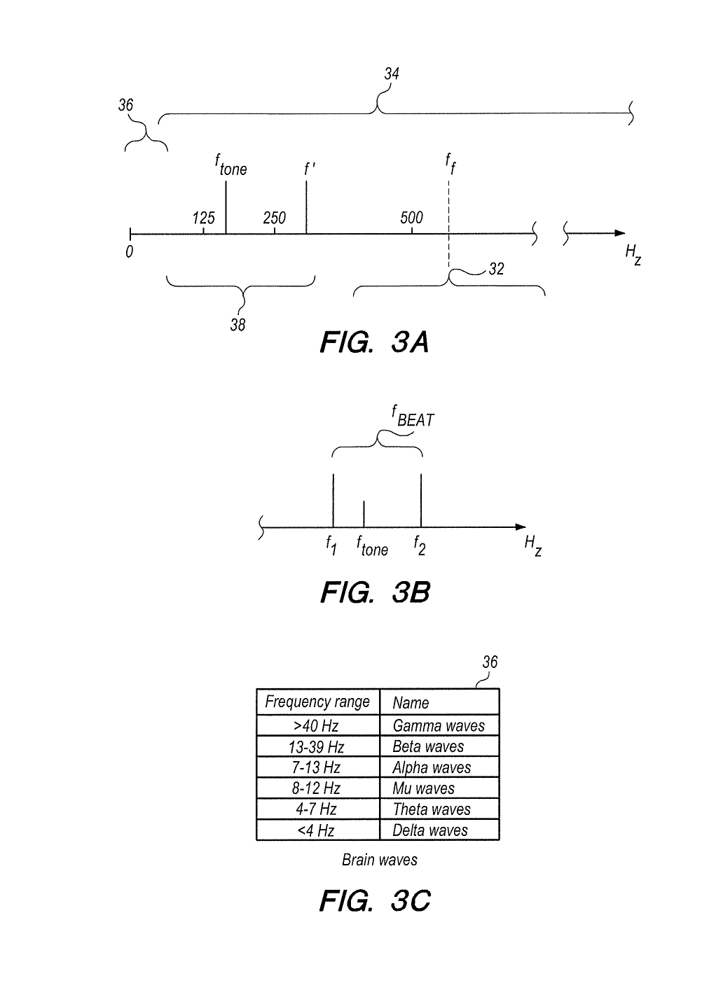

Referring now to FIG. 3A, it is shown that the ANS frequency range 32 which is used for stimulating the fundamental vibration frequency, f_{f}, lies within the audio range 34 of the user 30. FIG. 3A also shows that brain wave frequency ranges 36 are generally below the audio range 34 (see also FIG. 3C). Nevertheless, with this in mind, the present invention envisions aurally stimulating the user 30 with a preselected brain wave frequency 36. To do this, a fundamental tone, fₜₒₙₑ, is established within a tone spectrum 38 which, itself, is within a lower part of the audio range 34.

As shown in FIG. 3B, several aspects of the fundamental tone, fₜₒₙₑ, are illustrated. For one, fₜₒₙₑ is straddled by binaural frequencies, f₁ and f₂. For another, the difference between the binaural frequencies, f₁ and f₂, is the target beat frequency, f_{beat}. Thus, f_{beat}=f₂−f₁. As presented in FIG. 3C, the particular beat frequency, f_{beat}, that is to be used will depend on the physiological response that is desired for the user 30.

As will be appreciated by the skilled artisan, it may happen that the fundamental tone, fₜₒₙₑ, which is most appropriate for the user 30, will be the same as the fundamental vibration frequency, f_{f} (i.e. fₜₒₙₑ=f_{f}). However, it can also happen that, in order to more precisely and predictably establish the beat frequency, f_{beat} (i.e. a brain wave 36), it will be necessary to establish a fundamental tone, fₜₒₙₑ, that is lower in frequency than the fundamental vibration frequency, f_{f}. In such a case, it is necessary to establish an octave vibration relationship between the two frequencies, f_{f} and fₜₒₙₑ. As illustrated in FIG. 3A, such a relationship is shown wherein fₜₒₙₑ is established at two octaves below f_{f}. In this example, the intermediate frequency, f′, is selected at an octave below f_{f}, and fₜₒₙₑ is selected at an octave below f′.

In an operation of the system 10, after a fundamental vibration frequency, f_{f}, has been determined, and a fundamental tone, fₜₒₙₑ, has been identified, the transceiver 22 of the device 12 can be activated to connect the user 30 in communication with the database 18. The necessary fundamental tone, fₜₒₙₑ, can then be retrieved from the database 18 for use in a treatment protocol. In particular, using the fundamental tone, fₜₒₙₑ, the binaural frequencies, f₁ and f₂, are generated. Recall, f₂−f₁=f_{beat}. Accordingly, using beat frequency techniques, binaural frequencies, f₁ and f₂, are simultaneously transmitted to the user 30 from the device 12, via headphone 16. With this arrangement, f_{beat} will be sensed by the ANS of user 30 for the purposes of the present invention.

While the particular Autonomic Nervous System Balancing Device and Method of Use as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for balancing the Autonomic Nervous System (ANS) of a person to achieve a desired physiological response, which comprises:
a sensor for measuring a physiological function of the body of the person;
a computer for translating the physiological function measured by the sensor into a fundamental vibration frequency, f_{f}, wherein the fundamental vibration frequency, f_{f}, comports with an inflection between a sympathetic response and a parasympathetic response of the person, and is a characteristic of the ANS of the person;
a selector incorporated with the computer for identifying binaural frequencies from the fundamental vibration frequency, f_{f}, wherein the binaural frequencies are a first frequency, f₁, and a second frequency, f₂, and wherein the binaural frequencies, f₁ and f₂, are based on the fundamental vibration frequency, f_{f}, and are differentiated by a preselected beat frequency, f_{beat}; and
a headphone for simultaneously transmitting a respective binaural frequency to a respective auditory canal of the person to use the beat frequency, f_{beat}, for achievement of the desired physiological response.

2. A system as recited in claim 1 further comprising:
a database for archiving a library of tones for selective use as the fundamental tone, fₜₒₙₑ, wherein the database is located in a backup service; and
a transceiver for connecting the computer with the database for retrieving tones from the database for use by the analyzer.

3. A system as recited in claim 1 wherein the beat frequency, f_{beat}, is less than 40 Hz.

4. A system as recited in claim 1 further comprising an analyzer incorporated with the computer for isolating and evaluating a tone spectrum to establish the fundamental vibration frequency, f_{f}, as a fundamental tone, fₜₒₙₑ, for the person, and wherein the analyzer uses octave variation techniques to move the fundamental vibration frequency, f_{f}, into a tone spectrum where each binaural frequency, f₁ and f₂, is less than 1,000 Hz.

5. A system as recited in claim 4 wherein the fundamental vibration frequency, f_{f}, and the fundamental tone, fₜₒₙₑ, have an octave vibration relationship, wherein 2fₜₒₙₑ−f_{f}=0 and wherein f_{beat}=f₂−f₁.

6. A system as recited in claim 5 wherein f_{f}=fₜₒₙₑ.

7. A system as recited in claim 1 wherein the headphone comprises a pair of earbuds, with each earbud being individually engaged with a respective auditory canal of the person to transmit one of the binaural frequencies thereto.

8. A system as recited in claim 1 wherein the beat frequency, f_{beat}, is selected as a brain wave for appropriately achieving the desired physiological response.

9. A system as recited in claim 1 wherein the physiological function measured by the sensor is selected from a group consisting of heart rate and bio-impedance measurements.

10. A system as recited in claim 1 wherein the backup service is a cloud.

11. A method for balancing the Autonomic Nervous System (ANS) of a person to achieve a desired physiological response, which comprises the steps of:
measuring a physiological function of the body of the person;
translating the physiological function into a fundamental vibration frequency, f_{f}, wherein the fundamental vibration frequency, f_{f}, comports with an inflection between a sympathetic response and a parasympathetic response of the person, and is a characteristic of the ANS of the person;
evaluating a tone spectrum to establish the fundamental vibration frequency, f_{f}, as a fundamental tone, fₜₒₙₑ, for the person;
identifying binaural frequencies from the tone spectrum, wherein the binaural frequencies are a first frequency, f₁, and a second frequency, f₂, and wherein the binaural frequencies, f₁ and f₂, are based on the fundamental fₜₒₙₑ, of the person, and are differentiated by a preselected beat frequency, f_{beat}; and
simultaneously transmitting a respective binaural frequency to a respective auditory canal of the person to use the beat frequency, f_{beat}, for achievement of the desired physiological response.

12. A method as recited in claim 11 further comprising the steps of:
archiving a library of tones for selective use as the fundamental tone, fₜₒₙₑ, wherein the database is located in a backup service; and
retrieving a selected fundamental tone, fₜₒₙₑ, from the database for use in the identifying step.

13. A method as recited in claim 11 further comprising the step of using octave variation techniques to move the fundamental vibration frequency, f_{f}, into a tone spectrum where each binaural frequency, f₁ and f₂, is less than 1,000 Hz.

14. A method as recited in claim 11 further comprising the step of selecting the beat frequency, f_{beat}, to be a brain wave for appropriately achieving the desired physiological response.

15. A method as recited in claim 11 wherein the physiological function is selected from a group consisting of heart rate and bio-impedance measurements.

16. A method as recited in claim 11 wherein the fundamental vibration frequency, f_{f}, and the fundamental tone, fₜₒₙₑ, have an octave vibration relationship, wherein 2fₜₒₙₑ−f_{f}=0 and wherein f_{beat}=f₂−f₁.

17. A non-transitory, computer-readable medium having executable instructions stored thereon that direct a computer system to perform a process that comprises: measuring a physiological function of the body of the person; translating the physiological function into a fundamental vibration frequency, f_{f}, wherein the fundamental vibration frequency, f_{f}, comports with an inflection between a sympathetic response and a parasympathetic response of the person, and is a characteristic of the Autonomic Nervous System (ANS) of the person; evaluating a tone spectrum to establish the fundamental vibration frequency, f_{f}, as a fundamental tone, fₜₒₙₑ, for the person; identifying binaural frequencies from the tone spectrum, wherein the binaural frequencies are a first frequency, f₁, and a second frequency, f₂, and wherein the binaural frequencies, f₁ and f₂, are based on the fundamental tone, fₜₒₙₑ, of the person, and are differentiated by a preselected beat frequency, f_{beat}; and simultaneously transmitting a respective binaural frequency to a respective auditory canal of the person to use the beat frequency, f_{beat}, for achievement of the desired physiological response.

18. A device for use with a sensor to measure a physiological function of the body of the person, and with a headphone to balance the Autonomic Nervous System (ANS) of a person to achieve a desired physiological response, the device comprising:
a computer for translating the physiological function measured by the sensor into a fundamental vibration frequency, f_{f}, wherein the fundamental vibration frequency, f_{f}, comports with an inflection between a sympathetic response and a parasympathetic response of the person, and is a characteristic of the ANS of the person;
an analyzer incorporated with the computer for isolating and evaluating a tone spectrum to establish the fundamental vibration frequency, f_{f}, as a fundamental tone, fₜₒₙₑ, for the person;
a selector incorporated with the computer, and in connection with the analyzer for identifying binaural frequencies from the tone spectrum, wherein the binaural frequencies are a first frequency, f₁, and a second frequency, f₂, and wherein the binaural frequencies, f₁ and f₂, are based on the fundamental tone, fₜₒₙₑ, of the person, and are differentiated by a preselected beat frequency, f_{beat}; and
a connector for connecting the device with the headphone to simultaneously transmit a respective binaural frequency to a respective auditory canal of the person to use the beat frequency, f_{beat}, for achievement of the desired physiological response.

19. A device as recited in claim 18 further comprising:
a database for archiving a library of tones for selective use as the fundamental tone, fₜₒₙₑ, wherein the database is located in a backup service; and
a transceiver for connecting the computer with the database for retrieving tones from the database for use by the analyzer.

20. A device as recited in claim 18 wherein the beat frequency, f_{beat}, is less than 40 Hz; wherein the analyzer uses octave variation techniques to move the fundamental vibration frequency, f_{f}, into a tone spectrum where each binaural frequency, f₁ and f₂, is less than 1,000 Hz; wherein the beat frequency is selected as a brain wave for appropriately achieving the desired physiological response; and wherein the fundamental vibration frequency, f_{f}, and the fundamental tone, fₜₒₙₑ, have an octave vibration relationship with 2fₜₒₙₑ−f_{f}=0, and f_{beat}=f₂−f₁.
